(19) United States
(12) Patent Application Publication
(10) Pub. No.: US 2020/0409366 A1
(43) Pub. Date: Dec. 31, 2020

(54) REMOTE DEPLOYED OBSCURATION SYSTEM

(71) Applicant: Root3 Labs, Inc., Randallstown, MD (US)

(72) Inventors: Chad Michael Schneider, Owings Mills, MD (US); Christina Krueger, Glenwood, MD (US); Andrey Jasiukaitis, Ellicott City, MD (US)

(73) Assignee: Root3 Labs, Inc., Randallstown, MD (US)

(21) Appl. No.: 16/976,590

(22) PCT Filed: Mar. 5, 2019
(86) PCT No.: PCT/US19/20646

§ 371 Date: Aug. 28, 2020

Related U.S. Application Data
(60) Provisional application No. 62/638,441, filed on Mar. 5, 2018.

(51) Int. Cl. G05D 1/00; B64C 39/02; B64D 27/24; B64D 31/14; B64D 1/16; G05D 1/10; G05D 1/12; F42B 12/48

(52) U.S. Cl. CPC G05D 1/0094; B64C 39/024; B64D 27/24; B64D 31/14; B64D 1/16; G05D 1/101; B64C 2201/146; F42B 12/48; B64C 2201/027; B64C 2201/042; B64C 2201/108; B64C 2201/12; G05D 1/12

(57) ABSTRACT

The invention is that of a remote deployed obscuration system useful in protecting law enforcement and military personnel, for example, against attack. The remote deployed obscuration system comprises an unmanned aerial vehicle (UAV) such as a drone of any suitable configuration that is equipped with an obscuration means such as one or more smoke grenades. The remote deployed obscuration system is capable of being guided from a remote location via remote-control means in communication with a remote-control receiver of the UAV, which may be used to control UAV flight patterns, actuate the obscuration means, release and reload the obscuration means, and communicate with other remote deployed obscuration systems on a concerted mission. The obscuration means may comprise a quick mount and release mechanism of heat-resistant material to enable remote reloading of grenades, for example, while protecting the UAV against heat discharged therefrom.

### CROSS-REFERENCE TO RELATED APPLICATIONS

This application claims the benefit of the priority date of U.S. Provisional Patent App. No. 62/638,441, filed Mar. 5, 2018, the contents of which are hereby incorporated by reference in their entirety.

### STATEMENT REGARDING FEDERALLY SPONSORED RESEARCH

The invention described in this application was developed without federal funding.

### BACKGROUND OF THE INVENTION

Law enforcement and military personnel are often placed in dangerous situations as a function of their jobs, where if they are not able to proceed safely to another location, they could be injured, in some cases fatally by an aggressor seeking to do them harm. For example, and not by way of limitation, when a person becomes a target for an aggressor at some distance away, such as a sniper, the best way for the person to get himself or herself out of danger is to become invisible to the aggressor, either by moving to a location behind an adequate obstruction to the aggressor's view, or to impair the aggressor's vision such that the aggressor can no longer see the person.

Smoke screens have been used for many years by law enforcement and military personnel as a means for obscuring them from the view of aggressors seeking to target them with guns and other distance weapons. One way to generate a smoke screen is by way of a smoke grenade. A smoke grenade is typically deployed by manually pulling a pin from the grenade to initiate a chemical reaction that creates smoke, then throwing the grenade to the area where the operator wants to create the smoke screen.

This approach suffers from many shortcomings. First, it requires the operator to briefly engage the grenade with both hands to pull the pin. This is undesirable as in addition to the need to create the smoke screen, the operator may also have the need to use at least one hand to operate a gun, during a gunfire exchange for example. Next, a smoke grenade is only useful within the throwing distance of the operator, while an aggressor such as a sniper may be positioned, for example, on the top of a tall building outside the throwing distance of the grenade operator. Not only is the distance limitation a problem, but the accuracy with which personnel throw grenades may be highly variable, and inaccurate throws lead to the creation of smoke screens that are of no use to the operator and thus a waste of the grenade. Additionally, once the grenade is actuated and thrown, it is no longer mobile. Thus, if the purpose of the screen is to obscure the view of an aggressor near where the aggressor is positioned, the aggressor need only relocate to a position where the smoke screen no longer obscures his or her view of the operator to render the smoke screen ineffective.

In addition to the aforementioned shortcomings, a hand-thrown smoke grenade may have directly negative impacts on its operator. For example, if the grenade's destination is in relatively close proximity to its operator and, for example, the wind shifts in a way that blows smoke toward the operator, the operator has now obscured his or her own view of the surrounding area, thereby impairing the operator's ability to move to safety or, for example, attempt to terminate the aggressor using gunfire or the like. Finally, a smoke grenade by itself is only effective to a limited height above its landing position, which makes it useless for obscuring the view of an aggressor positioned at a height that is outside the effective range when throwing distance and smoke screen height in combination cannot reach it.

For these and other reasons, the present invention represents a significantly improved alternative to existing technology used to achieve the same goal.

### SUMMARY OF THE INVENTION

The invention of the present disclosure provides a means of obstructing the view of an aggressor in a manner that removes its target from danger or allows the target to move to a safer place. More specifically, the invention is directed toward an improved obscuration system that comprises a remotely guided unmanned aerial vehicle (UAV) that further comprises a means for generating smoke screens or equivalent means of obscuration. In one embodiment, the invention may be controlled remotely by an operator with a clear view of the aggressor through a remote-control panel with a visual display that receives signals from a camera mounted to the UAV.

The invention may be used to increase the safety and security of military and law enforcement personnel, for example. More specifically, the invention is that of an obscuration system that leverages the functionality of modern drone technology to provide an obscuration system that may be guided remotely to create smoke screens or functional equivalents that visually obscure law enforcement or military personnel, for example, from an aggressor seeking to harm them.

In one embodiment, the invention of the present disclosure is directed to a quad-rotor drone incorporating smoke grenades or equivalents proximal to each rotor that can be easily guided by a remote operator to any position between an active shooter or other aggressor and personnel under attack, or to any other location desired by the operator. The invention further comprises a means for actuating the smoke grenades or equivalent from a remote location. The number of obscurations that can be generated from the system is determined by the number of grenades mounted to the drone that can be actuated remotely, for example, by mechanical or electrical means of actuation.

The present invention may be used, for example and not by way of limitation, to obscure the position of personnel under attack such that the attacker cannot see the personnel.

### BRIEF DESCRIPTION OF THE DRAWINGS

FIG. 1 depicts a perspective view of an embodiment of the remote deployed obscuration system 100 of the present disclosure, configured as a quad-rotor drone 101 with at least one smoke grenade or equivalent 104 positioned below each rotor 102. The at least one smoke grenade or equivalent 104 is configured with a quick mount and release mechanism 105 that allows the user to quickly remove and replace the at least one smoke grenade or equivalent 104 between uses. The drone 101 further comprises landing gear 103.

FIG. 2 depicts a magnified view of a grenade assembly 200 of the invention of the present disclosure, with a smoke grenade or equivalent 104 positioned below a rotor 102 with a quick mount and release mechanism 105 comprising at least one clamp 201 for holding the at least one smoke grenade in place vertically and at least one sliding bracket 202 for holding the at least one smoke grenade in place horizontally.

FIG. 3 provides a front view of a remote deployed obscuration system of the present disclosure, with drone 101 at least one rotor 102 at least one quick release mechanism 105 at least one smoke grenade or equivalent 104 and landing gear 103.

FIG. 4 is a top view of a remote deployed obscuration system 100 of the present disclosure configured as a quad-rotor drone 101 with four rotors 102 landing gear 103 and four quick release mechanisms 105 holding four smoke grenades or equivalent in place.

FIG. 5 provides a side view of a remote deployed obscuration system 100 of the present disclosure, with a drone 101 configured with at least one rotor 102 landing gear 103 and at least one smoke grenade or equivalent 104 held in position by at least one quick release mechanism 105.

### DETAILED DESCRIPTION OF THE INVENTION

The invention of the present disclosure is that of a remote deployed obscuration system designed for use primarily by law enforcement and military personnel. In one embodiment, the invention is directed to a UAV incorporating an obscuration means such as at least one smoke grenade or equivalent that can be remotely controlled, either manually or by programming in advance, by use of a remote-control panel. The remote-control panel allows for the programming or control of flight speeds and patterns, as well as the actuation of the obscuration means, which may be for example and not by way of limitation, one or more smoke grenades. In one embodiment, at least one smoke grenade may be actuated through the triggering of a means for providing sufficient electrical current to the at least one grenade to initiate the chemical reaction or reactions necessary to produce a smoke screen. In another embodiment, a mechanical means of actuation may be used to “pull the pin” of at least one traditional mechanically activated smoke grenade.

The remote deployed obscuration system of the present disclosure provides several advantages over the prior methods of obscuration. One of ordinary skill in the art will recognize that UAVs by definition are guided remotely in terms of flight patterns and speeds, which may be used in the present invention to achieve specific patterns of obscuration or maintain obscuration of personnel from an aggressor on the move. One of ordinary skill in the art will also recognize that UAVs may be guided by a remote operator manually, or that an operator may program flight parameters in advance of deployment such that they may fly automatically to predetermined positions at predetermined rates of speed and may also be programmed to hold in predetermined patterns for predetermined periods of time. In a method of obscuration as enabled by the present disclosure, a remote deployed obscuration system of the present disclosure may be guided to any location desired by the operator but is most preferably guided to a position between an active shooter or other aggressor and personnel under attack. This allows the operator of the system to obscure the vision of the aggressor such that a person under attack is better enabled to defend himself or herself or move to a safer location.

One of ordinary skill in the art will appreciate that UAVs may be made in different sizes, shapes and configurations that affect how fast or high they can fly, and how quickly they can change positions. In one embodiment, the UAV is a drone, preferably a quad-rotor drone, carrying four smoke grenades, one underneath each rotor, although one of ordinary skill in the art will appreciate the fact that more or fewer rotors may be present, and that based on their dimensions, mounting positions and weights, more or fewer grenades may be mounted on the drone for remote deployment. One of ordinary skill in the art will also appreciate that based on the sizes, shapes and mounting positions of the grenades, the means used to mount each grenade may vary.

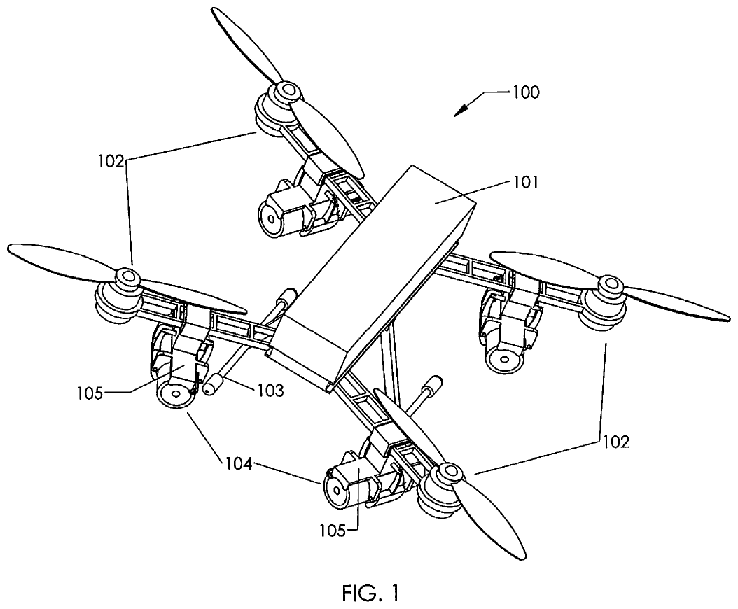

Turning now to FIG. 1, a remoted deployed obscuration system 100 as described herein comprises a quad-rotor drone 101 with four rotors 102 landing gear 103 and at least one smoke grenade 104 held in position beneath each rotor with a quick mount and release mechanism 105 that enables a user to quickly mount and release the at least one grenade. In FIG. 1, each quick mount and release mechanism 105 is connected to the drone 101 at a corresponding rotor arm such that the at least one smoke grenade 104 is positioned slightly inward from and below a corresponding rotor 102. One ordinary skill in the art will appreciate that depending on drone configuration and the desired effect of rotor air wash on obscuration patterns, a user may select a position for the at least one smoke grenade 104 from many compatible locations.

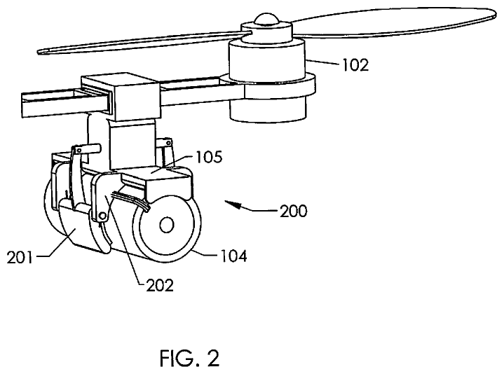

FIG. 2 provides a magnified view of an outer rotor arm 200 of the remote deployed obscuration system 100 of the present disclosure as depicted in FIG. 1, with smoke grenade 104 positioned beneath a rotor arm between a rotor 102 and the center of the drone, the smoke grenade 104 being held in position vertically by a clamp 201 and horizontally by a sliding bracket 202 of the quick mount and release mechanism 105. One of ordinary skill in the art will understand that the clamp 201 and sliding bracket 202 may be opened to release the smoke grenade 104 or closed to secure the smoke grenade 104 in place either manually or via remote control.

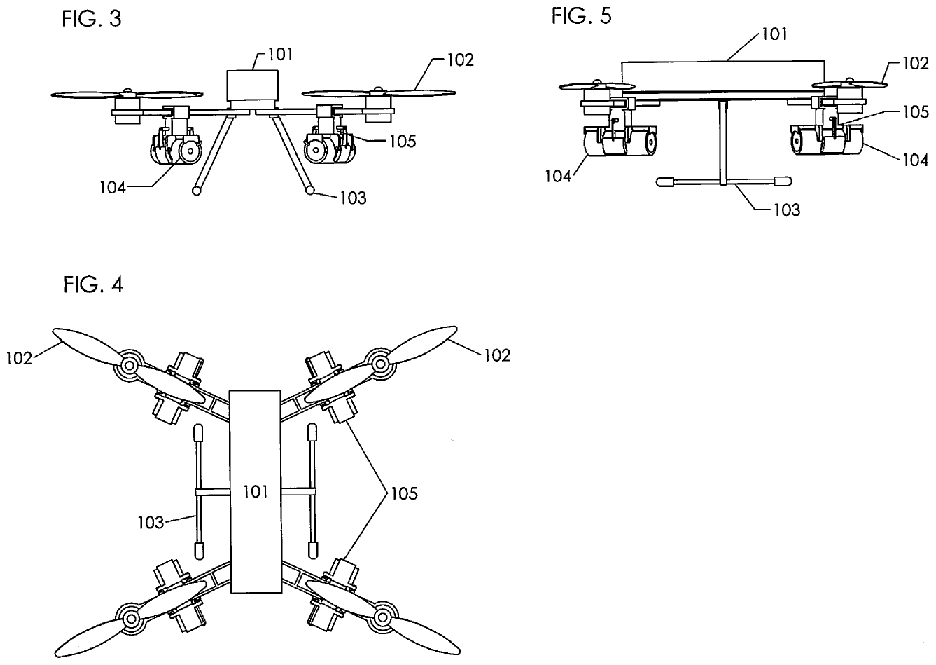

FIGS. 3-5 show a front, top and side view, respectively, of the remote deployed obscuration system 100 as shown in FIG. 1, with drone 101 rotors 102 landing gear 103 and at least one smoke grenade 105 held in position by a quick mount and release bracket 105.

In one embodiment of the remote deployed obscuration system 100 of the present disclosure, each smoke grenade 104 or equivalent is positioned via a quick mount and release bracket 105 that enables a user to quickly remove and replace each smoke grenade 104 or equivalent used as a means of obscuration of the present invention. The quick mount and release mechanism 105 feature enables a user to release and reload at least one smoke grenade 104 or equivalent before or after flight, or in-flight by hovering a drone 101 over a location where smoke grenades for refill are located, releasing at least one smoke grenade 104 that has been used, and lowing the drone 101 to a position where the quick mount and release mechanism 105 be used to reload remotely.

In certain embodiments, the quick mount and release mechanism 105 is made of heat-resistant material such as but not limited to aerogel, carbon fiber, fiberglass, basalt, silicone or aramid fiber. Heat-resistant material serves to insulate the drone 101 and its parts from the high heat released by an activated smoke grenade 104 and ensure continued operability. One of ordinary skill in the art will appreciate that UAVs comprise electrical control systems, motors, batteries, frames and propellers that may become compromised or fail if exposed to high temperatures. These components must remain functional to allow for control of the UAV, and that parts of those systems may fail if subjected to harmfully hot temperatures, as may be generated by an actuated smoke grenade. A smoke grenade casing may remain very hot long after emitting smoke, and therefore a means for insulating heat-sensitive parts of a system as described herein is required.

One of ordinary skill in the art will appreciate that at least one smoke grenade 104 or equivalent obscuration means may be selected by a user of the system described herein based on the specific application. Smoke grenades for use as described herein include but are not limited to those comprising colored smoke compositions such as potassium chlorate, hexachloroethane-zinc, granular aluminum, or white phosphorous, for example and not by way of limitation. In one embodiment, the smoke grenades or equivalents are actuated through a means of directing electrical current to them when the remote operator triggers a source. Alternatively, at least one smoke grenade 104 of the present disclosure may be mechanically actuated by, for example, equipping a drone of the present disclosure with a remote controllable means for pulling the pin of a traditional smoke grenade. As mentioned above, a means may be provided for ensuring that any heat produced by the grenades does not affect any of the components of the drone 101 in a way that hampers the ability of the remote operator to direct its flight or navigation.

The remote deployed obscuration system 100 of the present disclosure may be configured such that its weight is balanced as a result of grenade weight and placement. Additionally, at least one smoke grenade 104 or equivalent can be mounted in a location such that the UAV propellers' air wash improves the effectiveness of the smoke deployment. Flight patterns can also be used as a means for improving the effectiveness of a system as described herein.

The remote deployed obscuration system 100 of the present invention comprises a means for actuating at least one smoke grenade 104 or equivalent mounted to a drone 101 from a remote location. In one embodiment, for example and not by way of limitation, the system is equipped with a means of conducting sufficient electrical current to the at least one smoke grenade 104 or equivalent such that when actuated, the current initiates the necessary chemical reaction within the at least one smoke grenade 104 or equivalent to generate a smoke screen or equivalent means of obscuration. For this to be accomplished by a remote operator, the remote deployed obscuration system 100 must be equipped with an actuation means comprising a means for transmitting a signal to a point on the system that is in contact with the means of conduction electrical current such that the remote operator may initiate the generation of one or more smoke screens or equivalent, or program the remote control to do so.

A user may mount at least one smoke grenade 104 of the remote deployed obscuration system 100 of the present disclosure such that fumes of activated smoke grenades follow the flow path of the propellers' thrust. Some smoke grenades emit smoke from both ends of the casing when actuated. The major dimension of the at least one smoke grenade 104 as shown in FIG. 1, for example, is oriented tangentially to the rotational path of each corresponding propeller of the corresponding rotor 102. This orientation ensures that the smoke leaving each smoke grenade 104 is directed into and follows the downward air path generated by the propeller thrust. This allows the user to direct the location and pattern of the smoke screen created by the remote deployed obscuration system 100.

A remote deployed obscuration system 100 of the present disclosure may be positioned at the discretion of the remote operator by use of a remote-control panel (not shown). In one embodiment, the system is equipped with a digital video camera (not shown) positioned on a drone 101 that transmits images to the remote-control panel so that the operator can guide the drone from any location. This allows the remote operator to fly the drone 101 within a target area within which an aggressor is located to pinpoint the location of the aggressor, then move the drone 101 into position to generate smoke screen or equivalent in the manner that best obscures the aggressor's vision, affording personnel under attack a better opportunity to retaliate or move to safety. Alternatively, where an aggressor's location is known in advance, the system can be programmed to move to the location and obscure the aggressor's vision, freeing the remote operator to move into a position to assist personnel under attack by providing cover fire, for example.

One of ordinary skill in the art will appreciate that a variety of means may be used to achieve the most essential features of the present invention. For example, substitutable components of one prototype include a quad-rotor drone with ten-inch propellers, LiPo batteries to power drone flight and grenade firing, a commercially available flight controller with global positioning system, a programmable wireless radio system for controlling the drone, a relay for firing grenades that is wired to a receiver for remote control, electrical fire smoke grenades (wired individually or in series), and mounting hardware for the grenades. These are examples of various components that are available for purchase. One of ordinary skill will recognize that alternatives to each of these components exist.

In certain preferred embodiments, a UAV or equivalent may be fabricated using heat-resistant material that protects heat-sensitive components from heat that may be generated, for example, by smoke grenades mounted to the UAV. Alternatively, shielding may be used to protect said heat-sensitive components similarly.

Regardless of which specific individual components are selected, and differences in the capabilities and mode of action of each, the remote deployed obscuration system of the present invention offers law enforcement and military personnel, among others, a method of improving their occupational safety. In a method of the invention, a remote deployed obscuration system 100 is used or programmed by the operator to obscure the vision of an attacker positioned at a significant distance away from personnel under attack, in terms of horizontal distance, height or both, resulting in successful retaliation by the personnel under attack against the attacker or successful relocation to a place outside the line of attack.

A user of the remote deployed obscuration system 100 of the present disclosure may employ multiple UAVs to obscure the view of a single or multitude of aggressors, or to shroud and obscure one or more locations to obscure the visibility of personnel at those locations. Multiple systems of the invention may be configured for real-time communication with one another to enable them to adapt to changing locations of aggressors and targets, relative locations of drones 101, changing situational demands like the loss of one or more drones due to attack or the need to land, and changing conditions such as weather. Where a multitude of drones in communication with each other are used, they may be programmed to operate independently in a predetermined manner depending on the mission. The drones may be grouped or subgrouped according to mission instructions. They may be programmed for random flight patterns to avoid targeting and may fly in patterns that allow for the shrouding of one another with smoke to protect against attack.

A multitude of drones may be positioned vertically relative to one another such that the smoke created by the upper drones is propelled downward to increase the range or density of downwardly propelled smoke. They may also be positioned vertically with horizontal offsets. A slight lead of a drone flying higher than a following drone ensures that a smoke cloud from the higher drone is propelled downward and ahead of the following drone as the lead drone advances in flight. In this configuration, a leading drone will shroud the next drone beneath relative to an aggressor and so on, so an aggressor must work to target the lead drone in a series before being able to target each following drone in turn.

The remoted deployed obscuration system of the present disclosure is useful for conducting these and other missions. The system and methods described herein are provided by example and not way of limitation. Alternative embodiments as may be appreciated by one of ordinary skill in the art are incorporated by reference herein.

What is claimed is:

1. A remote deployed obscuration system comprising:
a UAV;
an obscuration means; and
a remote-control means comprising a means for directing the flight of the UAV.

2. The remote deployed obscuration system of claim 1, wherein the UAV is a drone comprising:
a frame comprising a remote-control receiver, at least one motor, at least one battery and at least one rotor arm;
at least one rotor configured with at least one propeller; and
an actuator configured for actuating the obscuration means;
wherein the remote-control receiver is configured to receive control commands from the remote-control means;
wherein the remote-control receiver is configured to control the at least one motor such that a user of the remote-control means may direct the flight of the drone by transmitting commands from the remote-control means to the remote-control receiver; and
wherein the remote-control receiver is configured to cause the actuator to actuate the obscuration means.

3. The remote deployed obscuration system of claim 2, wherein the obscuration means comprises at least one smoke grenade.

4. The remote deployed obscuration system of claim 3, wherein the smoke grenade comprises potassium chlorate, hexachloroethane-zinc, granular aluminum, white phosphorous or a combination thereof.

5. The remote deployed obscuration system of claim 2, wherein the actuator selected from the group consisting of electrical actuators, mechanical actuators, and combination thereof.

6. The remote deployed obscuration system of claim 5, further comprising at least one quick mount and release mechanism, wherein the at least one smoke grenade is held in a position by the at least one quick mount and release mechanism.

7. The remote deployed obscuration system of claim 6, wherein the at least one quick mount and release mechanism comprises at least one clamp and at least one sliding bracket, wherein the clamp is configured to hold the at least one smoke grenade in a vertical position and the at least one sliding bracket is configured to hold the at least one smoke grenade in a horizontal position.

8. The remote deployed obscuration system of claim 5, wherein the at least one quick mount and release bracket comprises a heat-resistant material.

9. The remote deployed obscuration system of claim 5, wherein the at least one quick mount and release bracket is mounted to the at least one rotor arm and beneath at least a portion of the at least one propeller.

10. The remote deployed obscuration system of claim 7, wherein the the at least one quick mount and release system is configured to release and reload the at least one smoke grenade in response to instructions from the remote-control means.

11. The remote deployed obscuration system of claim 8, wherein the heat-resistant material is selected from the group consisting of aerogel, carbon fiber, fiberglass, basalt, silicone and aramid fiber.

12. A method of obscuring at least one target from the view of at least one aggressor, the method comprising the steps of:
providing at least one remote deployed obscuration system according to claim 1;
programming the UAV to fly to a location suitable for obscuring the at least one target from the view of the at least one aggressor via the remote-control means; and
actuating the obscuration means.

13. A method of obscuring at least one target from the view of at least one aggressor, the method comprising the steps of:
providing at least one remote deployed obscuration system according to claim 3;
programming the drone to fly to a location suitable for obscuring the at least one target from the view of the at least one aggressor via the remote-control means; and
actuating, via the remote-control means, the at least one smoke grenade.

14. The method of claim 12, wherein the at least one remote deployed obscuration system is more than one remote deployed obscuration system, and each of the more than one remote deployed obscuration system is configured to communicate with the others of the more than one remote deployed obscuration system.
